(19) United States
(12) Patent Application Publication
(10) Pub. No.: US 2013/0295928 A1
(43) Pub. Date: Nov. 7, 2013

(54) USER TERMINAL AND COMMUNICATION METHOD

(71) Applicant: Mototsugu Suzuki, Chiyoda-ku (JP)

(72) Inventor: Mototsugu Suzuki, Chiyoda-ku (JP)

(73) Assignee: NTT DOCOMO, INC., Tokyo (JP)

(21) Appl. No.: 13/980,062

(22) PCT Filed: Sep. 11, 2012
(86) PCT No.: PCT/JP2012/073203

§ 371 Date: Jul. 17, 2013

(30) Foreign Application Priority Data
Sep. 16, 2011 (JP) 2011-203254

(51) Int. Cl. H04W 36/30

(52) U.S. Cl. CPC H04W 36/30
USPC 455/434

(57) ABSTRACT

A user terminal that is capable of performing communications according to a radio communication protocol of a first radio communication system and a radio communication protocol of a second radio communication system and includes a measured band specification unit that specifies a measured frequency band, whose communication quality is to be measured, based on frequency information indicating frequency bands used by the second radio communication system and transmitted from a first base station conforming to the first radio communication system; a cell search control unit that controls a process of measuring the communication quality of the measured frequency band; a target band setting unit that sets a target frequency band based on whether the communication quality of the measured frequency band is greater than or equal to a predetermined threshold; and a cell switch control unit that controls a process of switching to the target frequency band.

### TECHNICAL FIELD

This disclosure relates to a radio communication system.

### BACKGROUND ART

Specifications for the Long Term Evolution (LTE) are being formulated by the 3rd Generation Partnership Project (3GPP), a standardization group for the Wideband-Code Division Multiple Access (W-CDMA). The W-CDMA is also referred to as the Universal Mobile Telecommunications System (UMTS). The LTE is a standard evolved from the High Speed Packet Access (HSPA) that is an extended technology of the W-CDMA. The LTE is intended to achieve high-speed communications at a transmission rate of 100 Mbps or greater in downlink and at a transmission rate of 50 Mbps or greater in uplink, to reduce delay, and to improve frequency-use efficiency.

When an LTE system where radio communications are performed according to LTE is introduced, the LTE system may coexist with existing radio communication systems. Such existing radio communication systems include the 3rd generation radio communication system (which is hereafter referred to as a “3G system”).

Here, there exists a mobile terminal that supports handover between different mobile networks (see, for example, patent documents 1-3).

### RELATED-ART DOCUMENTS

### Patent Document

[Patent document 1] Japanese Laid-Open Patent Publication No. 2009-296077
[Patent document 2] Japanese Laid-Open Patent Publication No. 2010-533390
[Patent document 3] Japanese Laid-Open Patent Publication No. 2010-521905

### DISCLOSURE OF INVENTION

### Problems to be Solved by the Invention

There exists a method called “fast redirection” for switching between multiple radio communication protocols.

With the first redirection method, a user terminal can perform communications using both a radio communication protocol of the 3G system and a radio communication protocol of the LTE system.

The user terminal initiates a call to connect to a base station (3G base station) conforming to the 3G system. When initiating the call, the user terminal transmits, to the 3G base station, information (support information) indicating radio communication protocols that the user terminal supports, together with a connection request. The 3G base station is connected via a network to base stations (LTE base stations) conforming to LTE and therefore can detect an LTE base station located near the 3G base station. Here, there may be a case where a cell covered by the 3G base station completely overlaps a cell covered by the LTE base station and a case where a cell covered by the 3G base station partially overlaps a cell covered by the LTE base station.

When the support information transmitted from the user terminal includes the radio communication protocol of the LTE system and an LTE base station is detected near the 3G base station, the 3G base station rejects the connection request from the user terminal (RRC Connection Reject). When rejecting the connection request from the user terminal, the 3G base station transmits information (LTE frequency information) indicating the frequency band used by the detected LTE base station to the user terminal. The LTE frequency information may include information indicating a center frequency of a transmission band. Based on the LTE frequency information transmitted from the 3G base station, the user terminal searches for the LTE base station. Then, the user terminal connects to the LTE base station based on the search result and starts communications.

Next, an exemplary case where the 3G system uses one frequency band and the LTE system uses multiple frequency bands is described. In this exemplary case, it is assumed that the 3G system uses a first frequency band and the LTE system uses the first frequency band and a second frequency band.

When the LTE system uses the first frequency band and the second frequency band, the LTE frequency information transmitted from the 3G base station, which rejected the connection request, to the user terminal may include information indicating the first frequency band and information indicating the second frequency band.

When the LTE frequency information includes the information indicating the first frequency band and the information indicating the second frequency band, the user terminal measures the communication quality of both of the first frequency band and the second frequency band. Then, the user terminal switches to a frequency band and/or a cell having the better communication quality.

With the above method, because the user terminal needs to measure the communication quality of all frequency bands in the LTE frequency information, it takes time to switch to an LTE base station after the LTE frequency information is transmitted from the 3G base station. Also, measuring the communication quality of all frequency bands in the LTE frequency information increases the power consumption of the user terminal.

One object of the present invention is to reduce the time and power consumption necessary to switch between the 3G system and the LTE system.

### Means for Solving the Problems

In an aspect of this disclosure, there is provided a user terminal capable of performing communications according to a radio communication protocol of a first radio communication system and a radio communication protocol of a second radio communication system. The user terminal includes a measured band specification unit that specifies a measured frequency band, whose communication quality is to be measured, based on frequency information indicating frequency bands used by the second radio communication system and transmitted from a first base station conforming to the first radio communication system; a cell search control unit that controls a process of measuring the communication quality of the measured frequency band specified by the measured band specification unit; a target band setting unit that sets a target frequency band based on whether the communication quality of the measured frequency band measured in the process controlled by the cell search control unit is greater than or equal to a predetermined threshold; and a cell switch control unit that controls a process of switching to the target frequency band set by the target band setting unit.

### Advantageous Effect of the Invention

An aspect of this disclosure provides a technology that makes it possible to reduce the time and power consumption necessary to switch between a 3G system and an LTE system.

### BRIEF DESCRIPTION OF THE DRAWINGS

FIG. 1 is a drawing illustrating an exemplary wireless communication system;

FIG. 2 is a block diagram illustrating an exemplary configuration of a user terminal;

FIG. 3 is a drawing illustrating RSSI and RSCP;

FIG. 4 is a drawing illustrating RSRP and RSRQ;

FIG. 5 is a block diagram illustrating an exemplary functional configuration of a user terminal; and

FIG. 6 is a flowchart illustrating an exemplary process performed by a user terminal.

### DESCRIPTION OF EMBODIMENTS

Preferred embodiments of the present invention are described below with reference to the accompanying drawings.

Throughout the accompanying drawings, the same reference numbers are used for components having the same functions, and overlapping descriptions of those components are omitted.

### Embodiment

### Radio Communication System

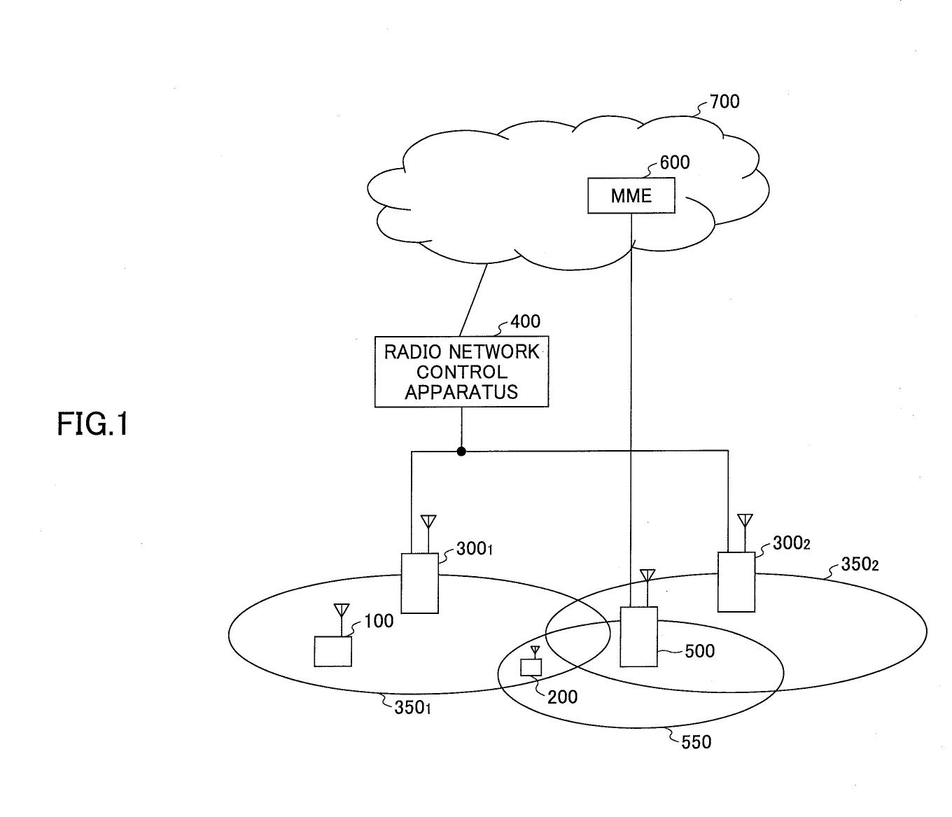

FIG. 1 illustrates an exemplary radio communication system where different types of radio communication systems coexist.

In the example of FIG. 1, the radio communication system includes a 3G system and an LTE system. The radio communication system may also include a 2G system. The 3G system may indicate a Universal Terrestrial Radio Access (UTRA) system. The LTE may be referred to as E-UTRA (Evolved Universal Terrestrial Radio Access)/E-UTRAN (Evolved Universal Terrestrial Radio Access Network).

However, the present embodiment may also be applied to systems other than the LTE and UTRA systems. For example, the present embodiment may also be applied to radio communication systems according to GERAN (GSM), CDMA 2000, and UMTS and to a 4th generation radio communication system.

The 3G system may include a user terminal (or user equipment: UE) 100, 3G base stations 300ₙ (300₁, 300₂), and a radio network control apparatus 400. The 3G system uses a first frequency band. For example, the first frequency band may be a 2 GHz band. However, the first frequency band is not limited to a 2 GHz band, and any other frequency band may be used as the first frequency band. Also, the 3G system may use two or more frequency bands.

The 3G base stations 300ₙ are connected to the radio network control apparatus 400, and the radio network control apparatus 400 is connected to a core network 700. The 3G base stations 300ₙ cover cells 350ₙ. The user terminal 100 communicates with the 3G base stations 300ₙ in the cells 350, according to a radio communication protocol of the 3G system. Although only one user terminal 100 is illustrated in FIG. 1, the 3G system may include two or more user terminals 100. Also, although two 3G base stations 300ₙ (300₁, 300₂) are connected to the radio network control apparatus 400 in FIG. 1, the number of the 3G base stations 300ₙ may be one or three or more. Further, two or more radio network control apparatuses 400 may be provided.

The LTE system may include a user terminal 200, an LTE base station 500, and an MME 600. The LTE system uses the first frequency band and a second frequency band. Alternatively, the LTE system may use one frequency band or three or more frequency bands. For example, the second frequency band may be an 800 MHz band. However, the second frequency band is not limited to an 800 GHz band, and any other frequency band may be used as the second frequency band.

The LTE base station 500 performs at least processes for the LTE system. The LTE base station 500 may be referred to as an access point (AP). The LTE base station 500 may also perform processes for the 3G system in addition to the processes for the LTE system. For example, the LTE base station 500 in the LTE system performs radio resource management, compression and encryption of IP headers, routing of user plane data, and scheduling of paging messages and broadcast information.

The LTE base station 500 is connected to the MME 600. The MME 600 is in the core network 700. The LTE base station 500 covers a cell 550. The user terminal 200 communicates with the LTE base station 500 in the cell 550 according to a radio communication protocol of the LTE system.

The MME 600 is connected via an S1 interface to the LTE base station 500. The MME 600 may be implemented by a switching center. The MME 600 manages the movement of the user terminal 200. For example, the MME 600 performs management of movement between 3GPP access networks, management of a tracking area list, selection of a gateway (GW) of a packet data network (PDN), selection of a serving gateway (GW), selection of a switching center (MME) in a handover process, roaming, authentication, management of radio access bearer, management of subscriber information, movement management, transmission and reception control, charge control, and QoS control.

Although only one user terminal 200 is illustrated in FIG. 1, the LTE system may include two or more user terminals 200. Also, although only one LTE base station 500 is connected to the MME 600 in FIG. 1, two or more LTE base stations 500 may be connected to the MME 600. Further, although only one MME 600 is illustrated in FIG. 1, the LTE system may include two or more MMEs 600.

The user terminal 200, which is capable of communicating with the LTE base station 500, can also communicate with the 3G base stations 300ₙ. In other words, the user terminal 200 is a dual mode terminal. A dual mode terminal can perform communications using a radio communication protocol of an existing radio communication system such as the 3G system and a radio communication protocol of the LTE system. In FIG. 1, it is assumed that the user terminal 100 can perform communications according to the radio communication protocol of the 3G system and the user terminal 200 can perform communications according to the radio communication protocols of the 3G system and the LTE system. The user terminal 200 related to the present embodiment is mainly described below.

### <User Terminal 200>

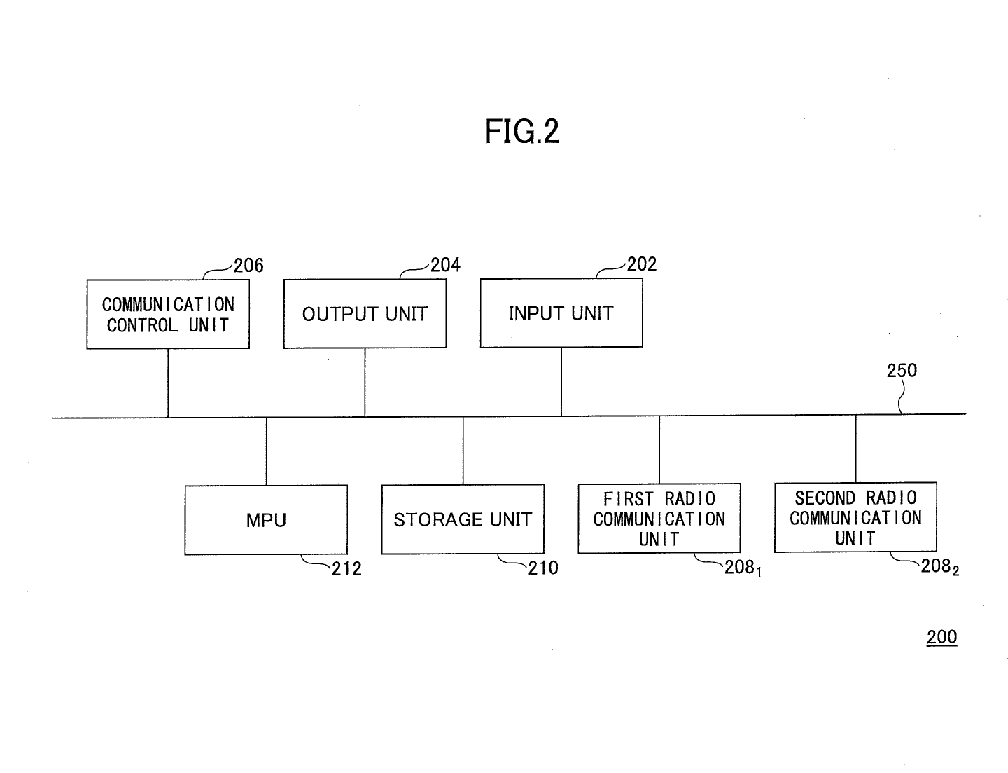

FIG. 2 is a drawing illustrating an exemplary configuration of the user terminal 200. FIG. 2 mainly illustrates a hardware configuration of the user terminal 200.

The user terminal 200 may be any appropriate terminal that allows the user to communicate. Examples of the user terminal 200 may include, but are not limited to, a cell phone, an information terminal, a personal digital assistant, a mobile personal computer, and a smartphone.

The user terminal 200 may include an input unit 202, an output unit 204, a communication control unit 206, a first radio communication unit 208₁, a second radio communication unit 208₂, a storage unit 210, and a micro processor unit (MPU) 212 that are connected to each other via a bus 250.

The MPU 212 controls the input unit 202, the output unit 204, the communication control unit 206, the first radio communication unit 208₁, the second radio communication unit 208₂, and the storage unit 210. The MPU 212 executes programs stored in the storage unit 210 to perform predefined processes.

The storage unit 210 stores applications and an operating system (OS). The applications are software that enables the user to perform various operations on the user terminal 200. The operating system is software that provides the applications with interfaces that are abstract representations of hardware components of the user terminal 200.

The input unit 202 is implemented, for example, by a keyboard and a mouse and used to enter instructions and data to the user terminal 200. Alternatively, the input unit 202 may be implemented by a touch panel. In this case, the input unit 202 and the output unit 204 may be implemented by the same touch panel. The input unit 202 may also be implemented by a microphone for inputting voices of the user. The voices may function as instructions to, for example, the operating system and the applications of the user terminal 200.

The output unit 204 is implemented, for example, by a display and used to display the status and results of processes performed by the user terminal 200. The output unit 204 may also be implemented by a speaker for outputting audio for the user. For example, the output unit 204 may output the status and results of processes performed by the operating system and the applications. Examples of the display include a liquid crystal display (LCD), a cathode-ray tube (CRT) display, a plasma display panel (PDP), and an organic electroluminescence (EL) display.

The communication control unit 206 generates an uplink signal directed to a network connected to the user terminal 200. The uplink signal is transmitted to one of the 3G base stations 300ₙ or the LTE base station 500 that is connected to the user terminal 200. The communication control unit 206 also analyzes a downlink signal(s) transmitted from the 3G base stations 300ₙ and/or the LTE base station 500 that is connected to the user terminal 200. During a cell search, the communication control unit 206 measures the communication quality of downlink signals from the 3G base stations 300ₙ. For example, the communication control unit 206 measures received signal code power (RSCP), received energy per chip divided by the power density in the band (Ec/No), and a received signal strength indicator (RSSI) of each downlink signal.

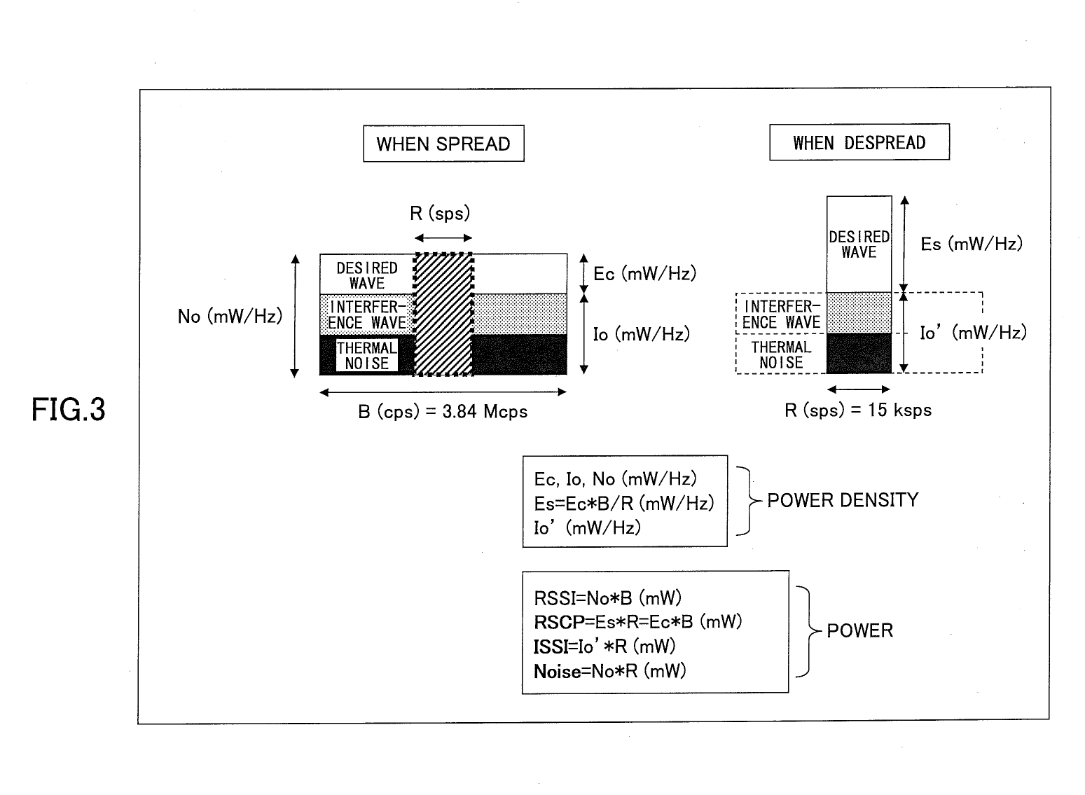

FIG. 3 illustrates RSSI and RSCP.

FIG. 3 also illustrates a desired wave, an interference wave, and thermal noise of a spread downlink signal; and a desired wave, an interference wave, and thermal noise of a despread downlink signal.

Ec (mW/Hz) indicates the power density of the desired wave of a spread downlink signal, Io (mW/Hz) indicates the total power density of the interference wave and the thermal noise of the spread downlink signal, and No (mW/Hz) indicates the total power density of the desired wave, the interference wave, and the thermal noise of the spread downlink signal. B (cps) is 3.84 Mcps and R(sps) is 15 ksps.

Es (mW/Hz) indicates the power density of the desired wave of a despread downlink signal, and Io′ (mW/Hz) indicates the total power density of the interference wave and the thermal noise of the despread downlink signal.

Es (mW/Hz) is expressed by Ec*B/R (mW/Hz). RSSI (mW) is expressed by No*B (mW). RSCP(mW) is expressed by Es*R=Ec*B (mW). ISSI (mW) is expressed by Io′*R (mW). Noise is expressed by No*R (mW).

During a cell search, the communication control unit 206 also measures the communication quality of a downlink signal from the LTE base station 500. For example, the communication control unit 206 measures reference signal received power (RSRP), reference signal received quality (RSRQ), and a received signal strength indicator (RSSI).

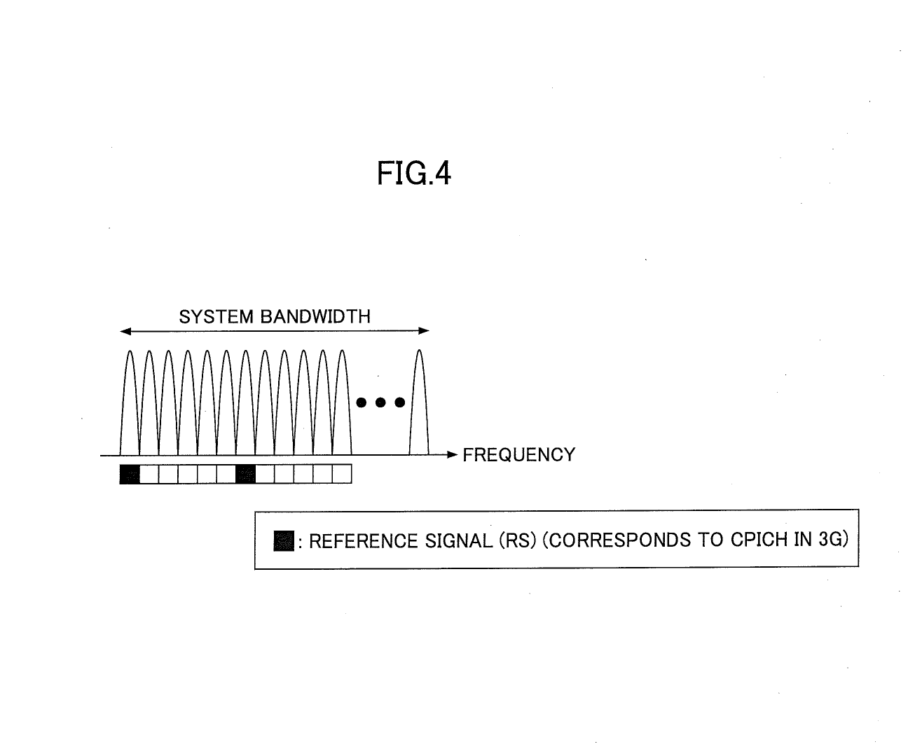

FIG. 4 illustrates reference signals. In FIG. 4, the horizontal axis indicates frequency. RSRP indicates the received power per subcarrier of reference signals in the entire system bandwidth. RSRQ is expressed by RSRP×number of resource blocks (RB)/RSSI.

The first radio communication unit 208₁ and the second radio communication unit 208₂ perform radio communications with the corresponding base stations according to the corresponding radio communication protocols under the control of the MPU 212. The radio communication protocols include the Global System for Mobile Communications (GSM), the Wideband-Code Division Multiple Access (W-CDMA), and the Long Term Evolution (LTE). The radio communication protocols may also include radio access methods succeeding the LTE. That is, the radio communication protocols may include any communication protocols available for cell phones. For example, each of the first radio communication unit 208₁ and the second radio communication unit 208₂ converts control information generated by the communication control unit 206 into a radio signal and converts a radio signal from a base station into a baseband signal.

In the user terminal 200 of the present embodiment, the first radio communication unit 208₁ performs communications according to the radio communication protocol of the 3G system and the second radio communication unit 208₂ performs communications according to the radio communication protocol of the LTE system.

### <Functional Configuration of User Terminal 200>

When initiating a call to the 3G base station, the user terminal 200 transmits support information to the 3G base station together with a connection request. In response, the user terminal 200 receives LTE frequency information from the 3G base station. The user terminal 200 may receive the LTE frequency information when the connection request is rejected by the network of the 3G system. The user terminal 200 performs a cell search based on the LTE frequency information. Then, the user terminal connects to a cell with good communication quality based on the result of the cell search and starts communications.

In the present embodiment, when a cell with communication quality greater than or equal to a predetermined threshold is detected in the cell search, the user terminal connects to the detected cell. This process is described below in more detail. When the LTE frequency information includes information indicating a first frequency band and information indicating a second frequency band, the user terminal 200 starts a cell search with one of the first frequency band and the second frequency band. For example, when the cell search is started with the first frequency band and a cell using a frequency band in the first frequency band and having a communication quality level greater than or equal to a predetermined threshold is detected, the user terminal 200 switches to the detected cell. Meanwhile, when no cell using a frequency band in the first frequency band and having a communication quality level greater than or equal to the predetermined threshold is detected, the user terminal 200 performs a cell search with the second frequency band. Based on the results of the cell search with the first frequency band and the second frequency band, the user terminal switches to a cell with the highest communication quality level.

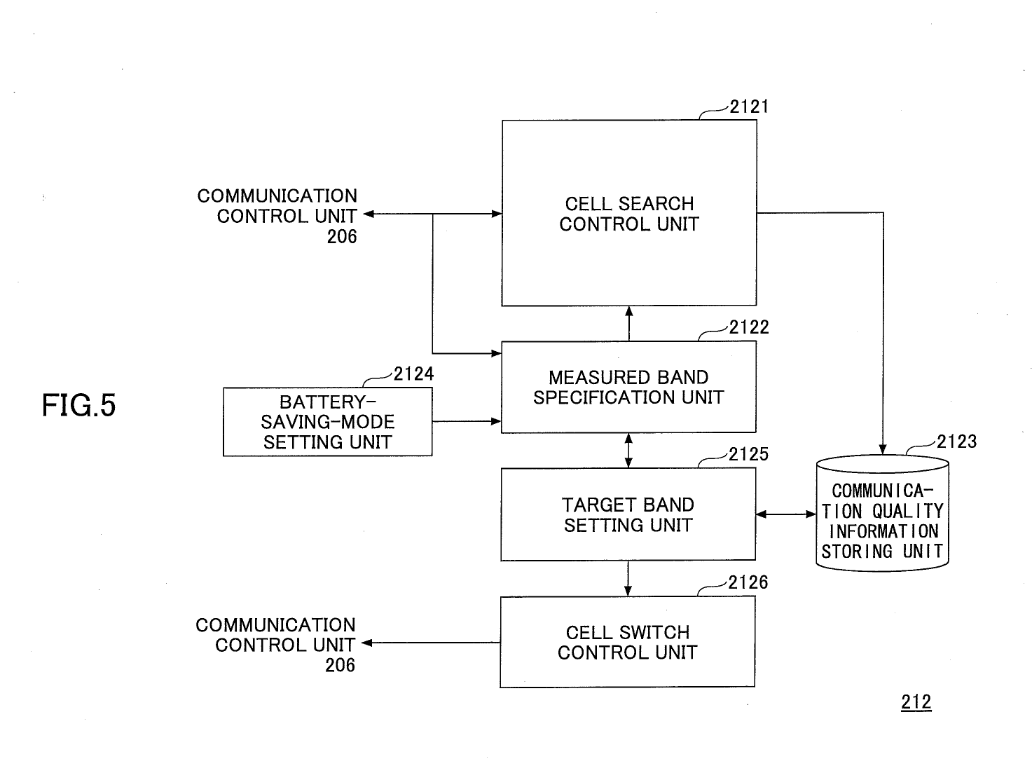

FIG. 5 is a block diagram illustrating an exemplary functional configuration of the user terminal 200. The functional units illustrated in FIG. 5 may be implemented by executing programs stored in the storage unit 210 by the MPU 212. Alternatively, the functional units illustrated in FIG. 5 may be implemented by firmware stored in the MPU 212.

The user terminal 200 may include a cell search control unit 2121, a measured band specification unit 2122, a communication quality information storing unit 2123, a battery-saving-mode setting unit 2124, a target band setting unit 2125, and a cell switch control unit 2126.

The cell search control unit 2121 is connected to the communication control unit 206. When a connection request from the user terminal 200 is rejected by the network of the 3G system, LTE frequency information transmitted from the 3G base station is input to the cell search control unit 2121. The cell search control unit 2121 controls a cell search process based on the LTE frequency information. More specifically, the cell search control unit 2121 receives information indicating a “measured” frequency band, whose communication quality is to be measured, from the measured band specification unit 2122 and inputs the information to the communication control unit 206.

The communication control unit 206 performs a cell search by controlling the second radio communication unit 208₂ based on the information indicating the frequency band input from the cell search control unit 2121. The communication control unit 206 measures the communication quality of a downlink signal received by the second radio communication unit 208₂ from the LTE base station 500. In other words, the communication control unit 206 measures the radio quality of a reference signal. Then, the communication control unit 206 inputs information indicating the communication quality of the downlink signal to the cell search control unit 2121.

The cell search control unit 2121 stores the information indicating the communication quality received from the communication control unit 206 in the communication quality information storing unit 2123.

The measured band specification unit 2122 is connected to the communication control unit 206 and the cell search control unit 2121. When a connection request from the user terminal 200 is rejected by the network of the 3G system, LTE frequency information transmitted from the 3G base station is input to the measured band specification unit 2122. The measured band specification unit 2122 specifies or selects a measured frequency band whose communication quality is to be measured in a cell search performed based on the LTE frequency information. More specifically, the measured band specification unit 2122 specifies a frequency band included in the LTE frequency information as the measured frequency band. When the LTE frequency information includes multiple frequency bands, the measured band specification unit 2122 selects one of the frequency bands When the communication quality between the user terminal 200 and the 3G base station rejecting the connection request is good, the measured band specification unit 2122 specifies, as the measured frequency band, a frequency band that at least partially overlaps a frequency band used for the connection request that has been rejected. Alternatively, the measured band specification unit 2122 may be configured to specify a frequency band that is close to the frequency band used for the connection request that has been rejected. This is because, due to frequency characteristics, a frequency band that at least partially overlaps or is close to a frequency band with good communication quality generally has good communication quality compared with other frequency bands.

The measured band specification unit 2122 inputs information indicating the measured frequency band to the cell search control unit 2121. Also, the measured band specification unit 2122 inputs, to the target band setting unit 2125, information indicating that the measured frequency band has been specified. Further, when information indicating that the communication quality of the measured frequency band is less than a threshold is reported from the target band setting unit 2125, the measured band specification unit 2122 specifies another frequency band as the measured frequency band.

The measured band specification unit 2122 may be configured to select a measured frequency band from frequency bands in the LTE frequency information when information indicating that the user terminal 100 has been set to a battery saving mode is input from the battery-saving-mode setting unit 2124. When so configured, the measured band specification unit 2122 does not select a measured frequency band from frequency bands in the LTE frequency information if the information indicating that the user terminal 100 has been set to the battery saving mode is not input from the battery-saving-mode setting unit 2124. Accordingly, in this case, cell searches are performed for all frequency bands in the LTE frequency information.

The battery-saving-mode setting unit 2124 is connected to the measured band specification unit 2122.

The battery-saving-mode setting unit 2124 sets the user terminal 200 to the battery saving mode in which the power consumption of a battery of the user terminal 200 is reduced. The battery-saving-mode setting unit 2124 may be configured to switch the user terminal 200 from a normal reception mode where a normal reception operation is performed to the battery saving mode when a predetermined period of time passes. The battery-saving-mode setting unit 2124 may also be configured to switch the user terminal 200 to the battery saving mode when instructed by the user via the input unit 202. After setting the user terminal 200 to the battery saving mode, the battery-saving-mode setting unit 2124 inputs, to the measured band specification unit 2122, information indicating that the user terminal 200 has been set to the battery saving mode.

The communication quality information storing unit 2123 is connected to the cell search control unit 2121. The communication quality information storing unit 2123 stores information indicating communication quality received from the cell search control unit 2121. More specifically, the communication quality information storing unit 2123 stores information indicating a frequency band for which a cell search has been performed in association with information indicating the communication quality of the frequency band.

The target band setting unit 2125 is connected to the measured band specification unit 2122 and the communication quality information storing unit 2123. When the information indicating that the measured frequency band has been specified is input from the measured band specification unit 2122, the target band setting unit 2125 determines whether the communication quality of the measured frequency band indicated by the information in the communication quality information storing unit 2123 is greater than or equal to a predetermined threshold and sets the measured frequency band as a target frequency band if the communication quality is greater than or equal to the predetermined threshold. Then, the target band setting unit 2125 inputs information indicating the target frequency band to the cell switch control unit 2126. Meanwhile, when the communication quality of the measured frequency band is less than the predetermined threshold, the target band setting unit 2125 inputs information indicating that the communication quality is less than the predetermined threshold to the measured band specification unit 2122.

The cell switch control unit 2126 is connected to the target band setting unit 2125. The cell switch control unit 2126 controls a process of switching to the target frequency band based on the information indicating the target frequency band input from the target band setting unit 2125. More specifically, the cell switch control unit 2126 controls the communication control unit 206 to access the target frequency band.

### <Process Performed by User Terminal 200>

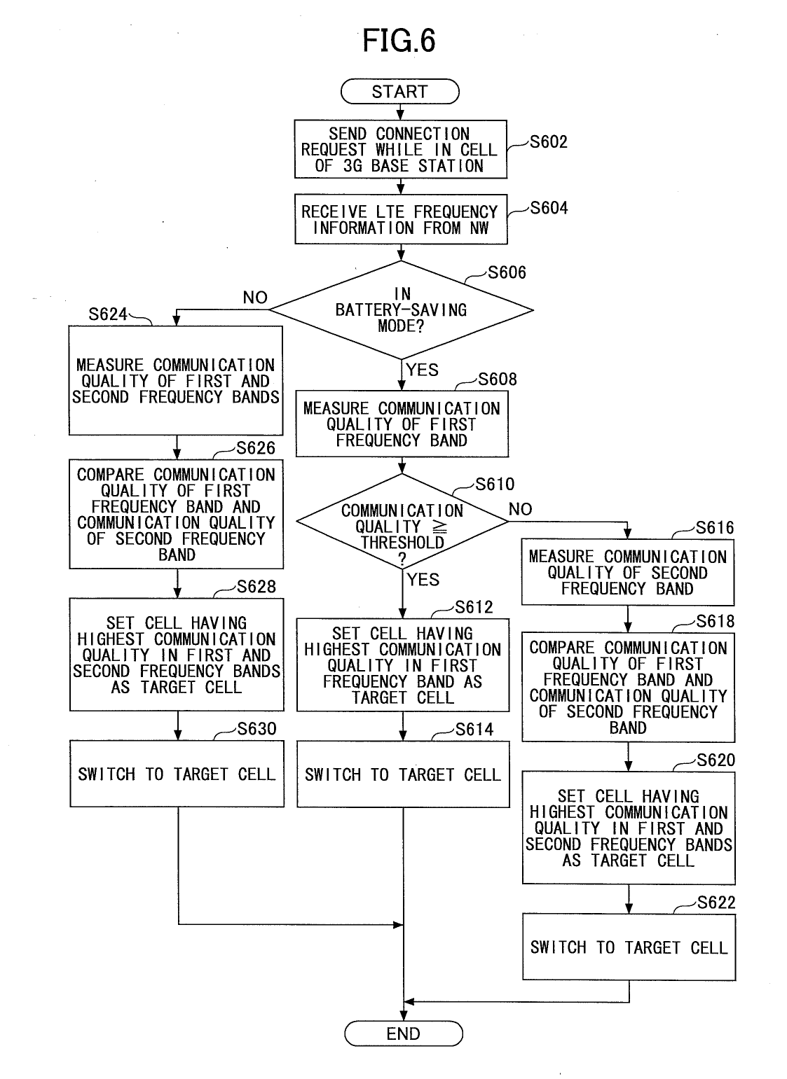

FIG. 6 is a flowchart illustrating an exemplary process performed by the user terminal 200. In the exemplary process of FIG. 6, it is assumed that the 3G system uses a first frequency band and the LTE system uses the first frequency band and a second frequency band.

The user terminal 200 transmits a connection request to a 3G base station 300ₙ while in the cell of the 3G base station 300ₙ (step S602).

In response, the user terminal 200 receives LTE frequency information from the network (NW) (step S604). The LTE frequency information from the 3G base station 300ₙ is received by the first radio communication unit 208₁ and input via the communication control unit 206 to the cell search control unit 2121 and the measured band specification unit 2122. The LTE frequency information includes information indicating the first frequency band and information indicating the second frequency band. The user terminal 200 may receive the LTE frequency information when the connection request is rejected by the network of the 3G system.

The user terminal 200 determines whether it is in the battery saving mode (step S606). More specifically, the measured band specification unit 2122 determines whether information indicating that the user terminal 200 is set to the battery saving mode has been received from the battery-saving-mode setting unit 2124.

When the user terminal 200 is in the battery saving mode (YES at step S606), the user terminal 200 measures the communication quality of the first frequency band (step S608). More specifically, when the information indicating that the user terminal 200 is set to the battery saving mode has been received from the battery-saving-mode setting unit 2124, the measured band specification unit 2122 inputs information indicating the first frequency band to the cell search control unit 2121. The cell search control unit 2121 performs a cell search based on the information indicating the first frequency band. The cell search control unit 2121 stores information indicating communication quality measured in the cell search in the communication quality information storing unit 2123. Also, the measured band specification unit 2122 inputs, to the target band setting unit 2125, information indicating that the first frequency band has been specified.

The user terminal 200 determines whether the communication quality of the first frequency band is greater than or equal to a threshold (step S610). More specifically, the target band setting unit 2125 determines whether the communication quality indicated by the information stored in the communication quality information storing unit 2123 is greater than or equal to the threshold.

When the communication quality of the first frequency band is greater than or equal to the threshold (YES at step S610), the user terminal 200 sets a cell having the highest communication quality in the first frequency band as a target cell (step S612). That is, when the communication quality of the first frequency band is greater than or equal to the threshold, the target band setting unit 2125 sets a cell having the highest communication quality in the first frequency band and as a target cell.

Then, the user terminal 200 switches to the target cell (step S614). More specifically, the cell switch control unit 2126 controls a process to switch to the target cell set in step S612.

Meanwhile, when the communication quality of the first frequency band is less than the threshold (NO at step S610), the user terminal measures the communication quality of the second frequency band (step S616). More specifically, when the communication quality indicated by the information stored in the communication quality information storing unit 2123 is less than the threshold, the target band setting unit 2125 inputs information indicating that the communication quality is less than the threshold to the measured band specification unit 2122.

When the information indicating that the communication quality is less that the threshold is input from the target band setting unit 2125, the measured band specification unit 2122 inputs information indicating the second frequency band to the cell search control unit 2121. The cell search control unit 2121 performs a cell search based on the information indicating the second frequency band. The cell search control unit 2121 stores information indicating communication quality measured in the cell search in the communication quality information storing unit 2123. Also, the measured band specification unit 2122 inputs, to the target band setting unit 2125, information indicating that the second frequency band has been specified.

The user terminal 200 compares the communication quality of the first frequency band with the communication quality of the second frequency band (step S618). That is, the target band setting unit 2125 compares the communication quality of the first frequency band and the communication quality of the second frequency band with each other.

The user terminal 200 sets a cell with the highest communication quality among cells using the first frequency band and the second frequency band as a target cell (step S620). That is, the target band setting unit 2125 sets a cell with the highest communication quality as a target cell based on the result of comparing the communication quality of the first frequency band and the communication quality of the second frequency band with each other.

Then, the user terminal 200 switches to the target cell (step S622). More specifically, the cell switch control unit 2126 controls a process to switch to the target cell set in step S620.

Also, when the user terminal 200 is not in the battery saving mode (NO at step S606), the user terminal measures the communication quality of the first frequency band and the second frequency band (step S624). More specifically, when the information indicating that the user terminal 200 is set to the battery saving mode has not been received from the battery-saving-mode setting unit 2124, the measured band specification unit 2122 inputs information indicating the first frequency band and information indicating the second frequency band to the cell search control unit 2121. The cell search control unit 2121 performs a cell search based on the information indicating the first frequency band and the information indicating the second frequency band. The cell search control unit 2121 stores information indicating communication quality measured in the cell search in the communication quality information storing unit 2123. Also, the measured band specification unit 2122 inputs, to the target band setting unit 2125, information indicating that the first frequency band and the second frequency band have been specified.

The user terminal 200 compares the communication quality of the first frequency band and the communication quality of the second frequency band with each other (step S626). That is, the target band setting unit 2125 compares the communication quality of the first frequency band and the communication quality of the second frequency band with each other.

The user terminal 200 sets a cell with the highest communication quality among cells using the first frequency band and the second frequency band as a target cell (step S628). That is, the target band setting unit 2125 sets a cell with the highest communication quality as a target cell based on the result of comparing the communication quality of the first frequency band and the communication quality of the second frequency band with each other.

Then, the user terminal 200 switches to the target cell (step S630). More specifically, the cell switch control unit 2126 controls a process to switch to the target cell set in step S630.

Steps S602 through S630 may be performed by the MPU 212 of the user terminal 200.

Programs for causing the MPU 212 to function as the user terminal 200 may be stored in and provided via a storage medium such as a flexible disk, a CD-ROM, or a memory card. The programs may also be downloaded via a network. When the storage medium is mounted on a storage drive of a computer, the programs are read into the computer. The MPU 212 stores the read programs in a RAM or an HDD and executes the programs. The programs cause the computer to perform all or a part of steps S602 through S630 of FIG. 6.

According to the present embodiment, a user terminal determines, based on LTE frequency information reported from a base station conforming to the 3G system and indicating frequency bands used by LTE base stations, whether the communication quality of the frequency bands is greater than or equal to a predetermined threshold. When a frequency band with communication quality greater than or equal to the predetermined threshold is detected, the user terminal switches to the detected frequency band. In other words, the user terminal can switch to a frequency band with communication quality greater than the predetermined threshold without needing to measure the communication quality of all the frequency bands included in the LTE frequency information. This configuration makes it possible to reduce the time and power necessary to switch cells.

Although specific values are used in the above descriptions to facilitate the understanding of the present invention, the values are just examples and other appropriate values may also be used unless otherwise mentioned.

The above embodiment may also be implemented as a communication method performed by a user terminal and a program executed by a user terminal.

The above embodiment is just an example, and a person skilled in the art may understand that variations and modifications may be made to the above embodiment.

Although functional block diagrams are used to describe apparatuses in the above embodiment, the apparatuses may be implemented by hardware, software, or a combination of them. The present invention is not limited to the specifically disclosed embodiments, and variations and modifications may be made without departing from the scope of the present invention.

The present international application claims priority from Japanese Patent Application No. 2011-203254 filed on Sep. 16, 2011, the entire contents of which are hereby incorporated herein by reference.

### EXPLANATION OF REFERENCES

100 User terminal
200 User terminal
300ₙ (n is an integer greater, than 0) 3G base station
350ₙ Cell
400 Radio network control apparatus
500 LTE base station
550 Cell
600 MME
700 Core network
202 Input unit
204 Output unit
206 Communication control unit
208₁ First radio communication unit
208₂ Second radio communication unit
210 Storage unit
212 MPU
250 Bus
2121 Cell search control unit
2122 Measured band specification unit
2123 Communication quality information storing unit
2124 Battery-saving-mode setting unit
2125 Target band setting unit
2126 Cell switch control unit

1. A user terminal capable of performing communications according to a radio communication protocol of a first radio communication system and a radio communication protocol of a second radio communication system, the user terminal comprising:
a measured band specification unit that specifies a measured frequency band, whose communication quality is to be measured, based on frequency information indicating frequency bands used by the second radio communication system and transmitted from a first base station conforming to the first radio communication system;
a cell search control unit that controls a process of measuring the communication quality of the measured frequency band specified by the measured band specification unit;
a target band setting unit that sets a target frequency band based on whether the communication quality of the measured frequency band measured in the process controlled by the cell search control unit is greater than or equal to a predetermined threshold; and
a cell switch control unit that controls a process of switching to the target frequency band set by the target band setting unit.

2. The user terminal as claimed in claim 1, wherein the measured band specification unit selects the measured frequency band, which at least partially overlaps or is close to a frequency band being used between the user terminal and the first base station, from the frequency information indicating the frequency bands used by the second radio communication system.

3. The user terminal as claimed in claim 1, wherein the measured band specification unit is configured to specify another frequency band when the communication quality of the measured frequency band measured in the process controlled by the cell search control unit is less than the predetermined threshold.

4. The user terminal as claimed in claim 1, further comprising:
a battery-saving-mode setting unit that sets the user terminal to a battery saving mode in which power consumption of a battery is reduced,
wherein the measured band specification unit specifies the measured frequency band when the user terminal is set to the battery saving mode by the battery-saving-mode setting unit.

5. A communication method performed by a user terminal capable of performing communications according to a radio communication protocol of a first radio communication system and a radio communication protocol of a second radio communication system, the method comprising:
a measured band specification step of specifying a measured frequency band, whose communication quality is to be measured, based on frequency information indicating frequency bands used by the second radio communication system and transmitted from a first base station conforming to the first radio communication system;
a cell search control step of controlling a process of measuring the communication quality of the measured frequency band specified in the measured band specification step;
a target band setting step of setting a target frequency band based on whether the communication quality of the measured frequency band measured in the process controlled by the cell search control step is greater than or equal to a predetermined threshold; and
a cell switch control step of controlling a process of switching to the target frequency band set in the target band setting step.
